(19) United States
(12) Patent Application Publication
(10) Pub. No.: US 2014/0088779 A1
(43) Pub. Date: Mar. 27, 2014

(54) SMART POWER STRIP AND SMART HOME SYSTEM USING THE SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/010,538

(22) Filed: Aug. 27, 2013

(30) Foreign Application Priority Data
Sep. 25, 2012 (CN) 2012103601383

(51) Int. Cl. H02J 4/00

(52) U.S. Cl. CPC H02J 4/00
USPC 700/295

(57) ABSTRACT

A smart power strip applied to a smart home system includes at least one socket connected to an electronic device, a plug configured to connect the smart power strip to the power supply, a storage, a wireless receiver, a Power Line Communication or Optical Fiber Power Line Communication modem unit, and a processor unit. The processor unit receives and stores wireless signals sent by a registration controller and generates a registration code, the Power Line Communication (PLC) or Optical Fiber Power Line Communication (OPLC) modem unit sends the registration code to the gateway via the power line, the registration code comprises a unique identification code of the smart power strip and a unique identification code of the registration controller. A smart home system is also provided.

### BACKGROUND

1. Technical Field

The present disclosure relates to smart home technology, and particularly to a smart power strip and a smart home system employing the smart power strip.

2. Description of Related Art

Power strip is a block of electrical sockets that attaches to an end of a flexible cable (typically with a mains plug on the other end), allowing multiple electrical devices to be powered from a single electrical socket. Power strips are often used when many electrical devices are in proximity.

Some power strips also include indicator light configured to indicate when power is on. However, that function of the power strip is the only function. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view showing a smart home system, according to an exemplary embodiment.

FIG. 2 is a block diagram of the smart home system of the FIG. 1.

FIG. 3 is a schematic view showing a smart power strip according to an exemplary embodiment.

FIG. 4 is a schematic view showing a smart home system, according to another exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

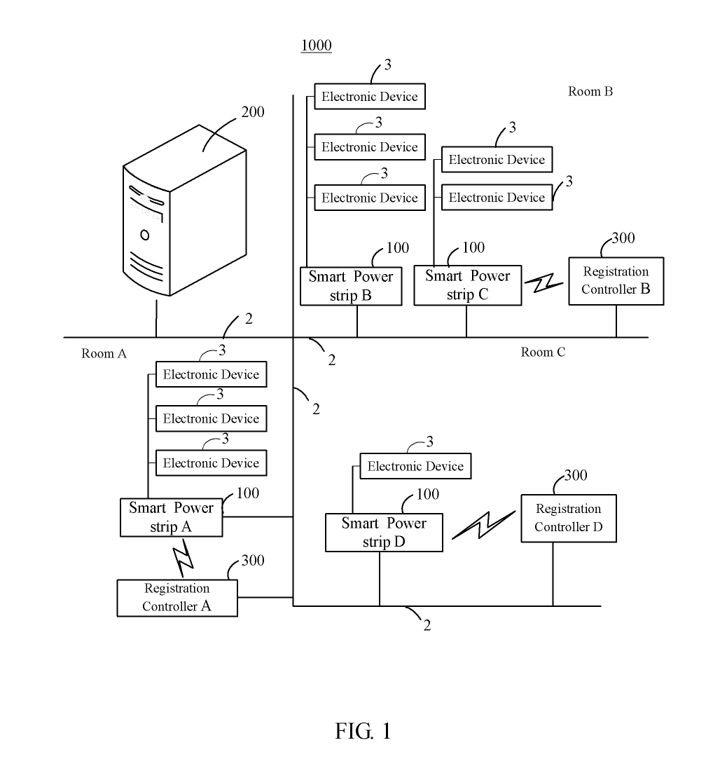

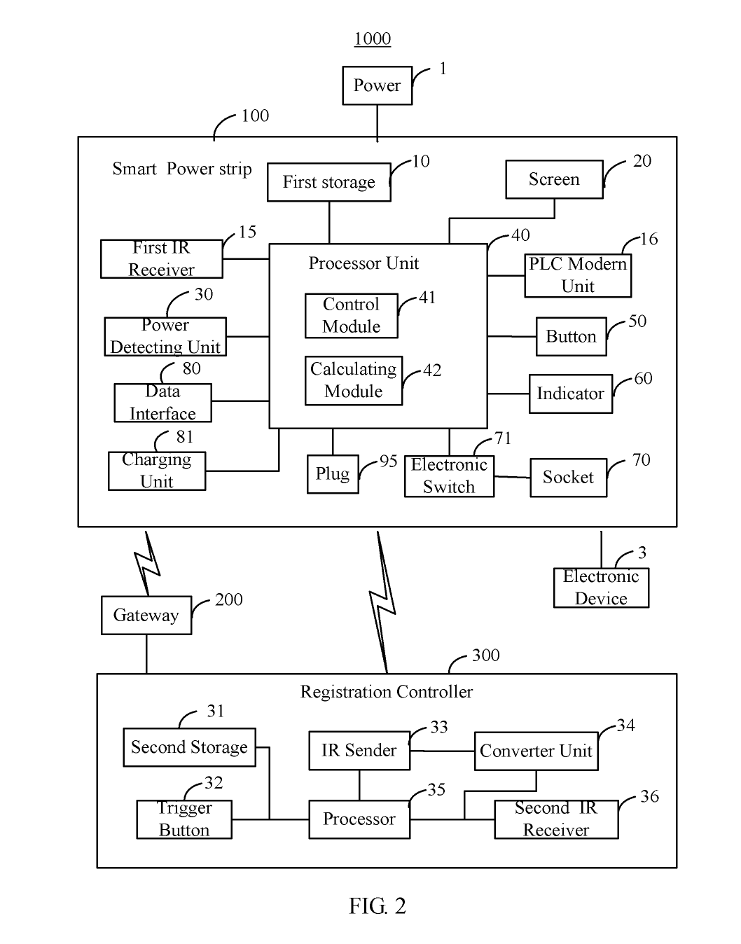

Referring to FIGS. 1 and 2, a smart home system 1000 in accordance with an exemplary embodiment is provided. FIG. 2 is a block diagram of the smart home system 1000. The smart home system 1000 includes a plurality of smart power strips 100, a gateway 200 connected to the smart power strips 100 via power line 2, a plurality of registration controllers 300 connected to the gateway 200 via power line 2 and a number of electronic devices 3 plugged into the smart power strips 100. The electronic devices 3 can be home appliances. The smart power strip 100 is connected to the gateway 200 via wires or wirelessly. The wired manner can be by Power Line Communication (hereinafter PLC), Optical Fiber Power Line Communication (hereinafter OPLC), wired internet communication, coaxial cable communication, telephone line communication, or other communication technologies. The registration controllers 300 are arranged in every room of a house employing the smart home system 100, and connected to the gateway 200 via the wires or wirelessly. User can use the registration controller 300 to control the smart power strips 100 in a room in which the registration controller 300 is located, to automatically register on the gateway 200. The smart power strip 100 connects the electronic devices 3 to a power 1.

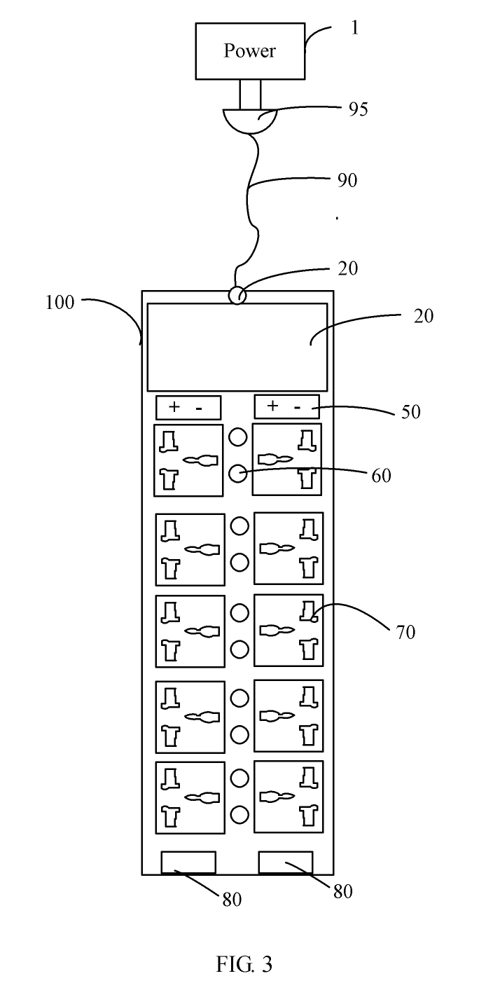

Referring to FIGS. 2 and 3, each smart power strip 100 includes a first storage 10, a screen 20, a power detecting unit 30, a processor unit 40, an electronic switch 71 and a number of sockets 70. The first storage 10, the screen 20, the electronic switch 71 and the power detecting unit 30 are connected to the processor unit 40. The electronic switch 71 is a relay. In other embodiments, the smart power strip 100 includes a number of electronic switches 71 corresponding to each of the sockets 70 on a one-to-one basis. The electronic devices 3 can be fridges, air-conditioners, computers, fans, TVs, lamps, micro wave ovens, and the like.

A formula is stored in the first storage 10 for calculating the energy charge. The power detecting unit 30 is configured to detect real-time information of the electronic devices 3 of the smart power strip 100, such as the instantaneous voltage, current or power consumption of the electronic devices 3. The real-time power consumption of the electronic device 3 is equal to the product of the real-time voltage and the real-time current thereof. The power detecting unit 30 further sends the real-time information to the processor unit 40. The screen 20 can be a LCD, an electronic paper display, an LED display, or a touch display. In other embodiments, the smart power strip 100 does not includes the screen 20, the functions of the screen 20 being implemented by a portable electronic device having a display connected to the gateway 200.

The processor unit 40 includes a control module 41 and a calculating module 42. The calculating module 42 calculates the total electrical consumption of the electronic device 3 according to their real-time power consumption. In an embodiment, the calculating module 42 obtains the power consumption P of the electronic device 3 detected by the power detecting unit 30 at a pre-determined interval t, and calculates the electrical consumption of the electronic device 3 in this time period t by the product of the power consumption P and the time period t. The total electrical consumption of the electronic device 3 is equal to the sum of the electrical consumptions of every time period t.

The calculating module 42 further calculates the energy charge of the electronic device 3 according to the formula stored in the first storage 10, an electrovalence, and the total electrical consumption, the control module 41 controls the screen 20 to display the real-time information, the total electrical consumption and the energy charge of the electronic device 3.

The control module 41 further controls the electronic switch 71 to turn on or turn off the power supply of the socket 70 according a command sent by the gateway 200, thereby controlling the power supply to the electronic devices 3 connected on the smart power strip 100.

The smart power strip 100 further includes a data interface 80 connected to the processor unit 40, supporting data interoperability between the smart power strip 100 and another device. In this embodiment, the data interface 80 is a USB interface. The smart power strip 100 further includes a charging unit 81 configured to charge a device via the data interface 80. The control module 41 further controls the screen 20 to display a charging status of the device connected on the data interface 80, such as top-off, charging and rest time.

The smart power strip 100 further includes a button 50 and a number of indicators 60 connected to the processor unit 40. One indicator light 60 corresponds to one socket 70, and is configured to indicate that the power supply of the socket 70 is on or off. In this embodiment, the indicator light 60 emits light to indicate that the power supply of the socket 70 is on, and is dark to indicate that the power supply of the socket 70 is off. The button 50 sends a first signal to the processor unit 40 in response to a first pressing gesture on it, the control module 41 of the processor unit 40 resets the total electrical consumption and the energy charge of the electronic device 3 displayed on the screen 20 in response to the first signal, and the calculating module 42 once again calculates the total electrical consumption and the energy charge of the electronic device 3. The button 50 sends a second signal in response to a second pressing gesture to the processor unit 40, the control module 41 of the processor unit 40 controls the screen 20 to display an input box beside the total electrical consumption for receiving a new electrovalence input by a user. In an embodiment, the first pressing gesture is a short press gesture, such as pressing for 0.5 second; the second pressing gesture is a long press gesture, such as pressing for more than 3 seconds.

In an embodiment, the smart power strip 100 further includes a plug 95 and a flexible cable 90 connecting to the plug 95, the plug and the flexible cable are configured to connect the smart power strip 100 to the power 1, thus connecting the power 1 and the electronic devices 3. The socket 70 can be a three-phase or two-phase socket.

When two or more electronic devices 3 are connected on the smart power strip 100 via the sockets 70, the power detecting unit 30 can detect the real-time information of each electronic devices 3 and send the real-time information to the processor unit 40. The calculating module 42 calculates the total electrical consumption and the energy charge of each electronic device 3, and the control module 41 controls the screen 20 to display the real-time information, the energy charge, and the total electrical consumption of each electronic device 3. The smart power strip 100 includes a number of indicator 60, each of the indicator 60 is related to one socket 70 of the smart power strip 100 and is configured to indicate the power state of the electronic device 3 connected on the related socket 70. Also, the smart power strip 100 includes a number of buttons 50, each of the buttons 50 is related to one socket 70 of the smart power strip 100 and is configured to reset the total electrical consumption and the energy charge of the electronic device 3 connected on the related socket 70. In another embodiment, the smart power strip 100 only includes one button 50, and when the button 50 is pressed, the control module 41 of the processor unit 40 resets the total electrical consumption and the energy charge of all of the electronic devices 3.

Users can obtain the real-time information, the total electrical consumption, and the energy charge of the electronic device 3 from the screen 20, and obtain charging status of the device connected to the data interface 80.

User can use the registration controllers 300 to control the smart power strips 100 in a room in which the registration controller 300 is located, to automatically register on the gateway 200. In detail, the smart power strips 100 send a unique identification code (UID) to the gateway 200, to register on the gateway 200. In the first embodiment, the smart power strip 100 includes a number of sockets, each of the sockets has a UID, the smart power strips 100 further sends the UIDs of the sockets to the gateway 200, thereby the sockets are registered on the gateway 200. Each of the registration controllers 300 also includes an UID stored therein. A registration process of how the smart power stripes 100 register on the gateway 200 is given.

Referring to FIG. 1, the gateway 200, a number of the smart power strips 100 and the registration controllers 300 are connected to the power line 2, and capable of communicating with each other via PLC (or OPLC). In this embodiment, the smart power strips 100 include a smart power strip A 100, a smart power strip B 100, a smart power strip C 100 and a smart power strip D 100. The registration controllers 300 include a registration controller A 300, a registration controller B 300 and a registration controller D 300. The smart power strip A 100 and the registration controller A 300 are located in a room A, the smart power strip B 100, the smart power strip C 100 and the registration controller B 300 are located in a room B, and the smart power strip D 100 and the registration controller D 300 are located in a room C. The gateway 200 can automatically communicate with all devices connected on the power line 2 via PLC (or OPLC).

The smart power strip 100 further includes a first infrared (IR) receiver 15 configured to receive IR signals sent by the registration controller 300, and a PLC modem unit 16. The PLC modem unit 16 is configured to receive and decode the data transmitted on the power line 2, the PLC modem unit 16 also encodes and forwards the data to the gateway 20 via the power line 2, thereby establishing communication between the smart power strip 100 and the gateway 200. In other embodiments, the first IR receiver 15 can be a receiver employing other wireless communication technologies.

Referring to FIG. 2, the registration controller 300 includes a second storage 31, a trigger button 32, an IR sender 33, a converter unit 34, a processor 35 and a second IR receiver 36.

The registration controller 300 needs to be connected to the gateway 200, before the smart power strips 100 register on the gateway 200. To connect the registration controller 300, the registration controller 300 is located within the communicating range of the gateway 200, and a coupling program is run on the smart gateway 20. Then, the smart gateway 200 establishes communication with the registration controller 300, and sends its own UID and a secret code to the registration controller 300 wirelessly. The registration controller 300 receives and saves the UID of the gateway 200 and the secret code into the second storage 31. The registration controller 300 further sends its own UID to the gateway 200 wirelessly, the gateway 200 receives and saves the UID of the registration controller 300, to finish the coupling process. In this embodiment, the registration controller 300 receives the UID of the gateway 200 and the secret code via the second IR receiver 36, and sends the UID of the registration controller 300 to the gateway 200 via the IR sender 33. In this embodiment, the secret code is the UID of the gateway 200 or the secret code is input by the user. The secret code is configured to encode or decode the data transmitted between the gateway 200 and the registration controller 300, prevent unauthorized access to the data. In other embodiments, the gateway 200 and the registration controller 300 can communicate via BLUETOOTH, Z-WAVE, NFC, ZIGBEE, WIFI, or other communication technologies.

If user wants to register the smart power strips 100 on the gateway 200, user must locate the connected registration controller 300 in the room containing the smart power strips 100 which need to be registered, and run a registering program on the mart gateway 200.

For example, the connected registration controller B 300 shown in FIG. 1 is located in the room B, the smart power stripes B and C 100 are also located in the room B. The trigger button 32 generates a trigger signal in response to user's pressing on it, and sends the trigger signal to the processor 35. The processor 35 controls the IR sender 33 to send a registration request to the gateway 200 via wires or wirelessly, and to send an IR signal in response to the trigger signal. The smart power strips 100 arranged in the room B can receive the IR signal. In this embodiment, the registration controller B sends the registration request to the gateway 200 via the power line 2 in response to the trigger signal. The IR signal includes the UID of the registration controller B 300, the UID of the gateway 200, and the secret code sent by the gateway 200. The smart power strips B and C 100 stores the UID of the registration controller B and the secret code contained in the IR signal into the first storage 10. The registration request includes the UID of the registration controller B 300 and UID of the gateway 200.

The smart power strips 100 can be registered to the gateway in different ways. In a driven registration manner, the gateway 200 broadcasts a signal to all of the smart power strips 100 connected on the power line for determining whether the smart power strip 100 had received the IR signal sent by the registration controller 300, in response to the received registration request. The smart power strips 100 which receive the IR signal send an encoded registration code to the gateway 200 through wires or wirelessly, in response to the broadcast signal. In this embodiment, the smart power strips 100 are registered on the gateway 200 in the driven registration manner.

In this example, the smart power strips B and C 100 located in the room B send an encoded registration code to the gateway 200 by wires or wirelessly, in response to the broadcast signal. The smart power stripes B and C 100 can send the encoded registration code to the gateway 200 via the power line. The registration code includes the UID of the smart power strip 100 and the UID of the registration controller 300 stored in the first storage 10. If the smart power strip 100 includes more than one socket, the registration code further includes the UID of each socket.

The gateway 200 decodes the registration code and determines whether or not the UID of the registration controller 300 contained in the registration code matches the UID of the registration controller 300 contained in the registration request, and if yes, the gateway 200 stores the UID of the smart power strip 100. In this way, the smart power strip 100 is registered on the gateway 200, the gateway 200 can send control signals including the UID of the target smart power strip 100, and the smart power strip 100 determines whether the UID of the received control signal matches its own UID, only the matching smart power strip 100 can parse the control signals, thus creating a point-to-point communication between the gateway 200 and the smart power strip 100.

In an embodiment, the converter unit 34 of the registration controller 300 is configured to receive the control signals from the power line 2 sent by the gateway 200 and convert the control signals. The IR sender 33 sends the converted control signals to the smart power strip 100 to control the electronic device 3 connected on the smart power strip 100.

In a forward registration manner, the smart power strip 100 which receives the IR signal sends an encoded registration code to the gateway 200 directly, instead of the utilization of the driven registration manner. The other registration processes in the forward registration manner are the same as those in the driven registration manner, and are not repeated here.

All the signals transmitted between the smart power strips 100, the gateway 200, and the registration controller 300 via the power line 2, include the UID of the device which sends the signals and the UID of the device which is to receive the signals. Furthermore, a secret code is used to encode the signals transmitted between the smart power strips 100, the gateway 200, and the registration controller 300 via the power line 2, and the secret code is stored in smart power strips 100, the gateway 200, and the registration controller 300.

In an embodiment, the registration controller 300 has the same appearance and function of the smart power strips 100, the difference between the registration controller 300 and the smart power strips 100 is that the registration controller 300 further includes a trigger button 32 and an IR sender 33. The registration controller 300 not only serves to control the smart power stripes 100 to automatically register on the gateway 200, but also acts as a smart power strip.

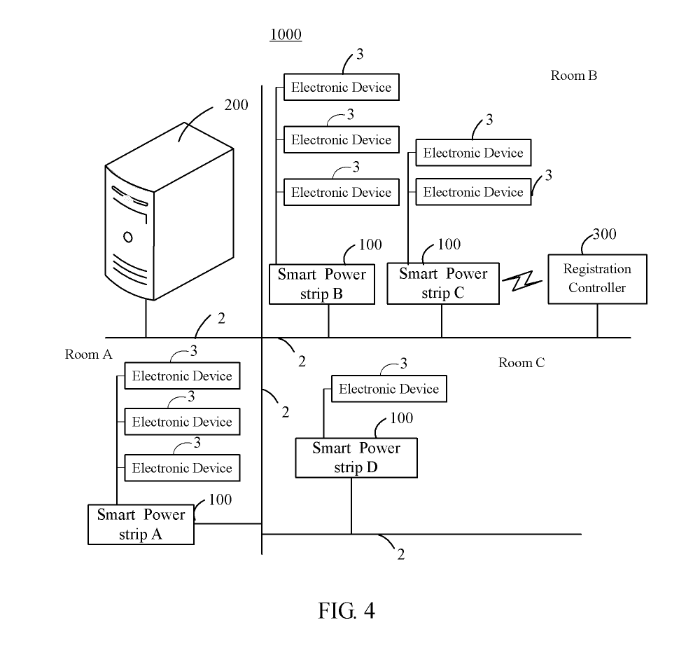

Referring to FIG. 4, in another embodiment, only one registration controller 300 is employed in the smart home system 1000

The registration controller 300 is connected to the gateway 200, before the smart power strips 100 register on the gateway 200, and the coupling process of the second embodiment is the same as that of the first embodiment.

If user wants to register the smart power strips 100 on the gateway 200, user must locate the connected registration controller 300 in the room which contains the smart power stripes 100 which need to be registered, and run a registering program on the smart gateway 200.

For example, the connected registration controller 300 shown in FIG. 3 is located in the room B, and the smart power strips B and C 100 are also located in the room B. The trigger button 32 generates a trigger signal in response to user's pressing on it, and sends the trigger signal to the processor 35. The processor 35 controls the registration controller 300 to send a registration request to the gateway 200 via wires or wirelessly. In this embodiment, the registration controller 300 sends the registration request to the gateway 200 via the power line 2 in response to the trigger signal. The gateway 200 generates a serial code and sends the serial code to the registration controller 300 via wires or wirelessly, in response to the registration request. In this embodiment, the gateway 200 sends the serial code to the registration controller 300 via the power line 2. The serial codes generated by the gateway 200 responding to the registration request are different each time, and in this embodiment, the serial codes are generated according to the timestamp of the received registration request. For example, the first time that the gateway 200 receives the registration request, the gateway 200 generates a first serial code, such as 01; the second time that the gateway 200 receives the registration request, the gateway 200 generates a second serial code such as 02.

The processor 35 of the registration controller 300 controls the IR sender 33 to send an IR signal in response to the received serial code, the IR signal includes the serial code, the UID of the registration controller 300, the UID of the gateway 200, and the secret code sent by the gateway 200. The smart power strips B and C 100 can receive the IR signal. The smart power strips B and C 100 store the serial code, the UID of the registration controller 300, and the secret code contained in the IR signal into the first storage 10.

The gateway 200 further broadcasts a signal to all of the smart power strips 100 connected on the power line for determining whether the smart power strip 100 has received the IR signal sent by the registration controller 300. The smart power strips 100 which have received the IR signal send an encoded registration code to the gateway 200 via the power line 2, in response to the broadcast signal. In this embodiment, the smart power strips 100 are registered on the gateway 200 in a driven registration manner

In this embodiment, the smart power strips B and C 100 arranged in room B send the encoded registration code to the gateway 200 in response to the broadcast signal. The registration code includes the serial code, the UID of the smart power strip 100 and the UID of the registration controller 300 stored in the first storage 10. If the smart power strip 100 includes more than one socket, the registration code further includes the UID of each socket.

The gateway 200 decodes the registration code and determines whether the UID of the registration controller 300 contained in the registration code matches the UID of the registration controller 300 contained in the registration request, and if yes, the gateway 200 stores the UID of the registration code. In this way, the smart power strip 100 is registered on the gateway 200, the gateway 200 can send control signals including the UID of the target smart power strip 100, and the smart power strip 100 determines whether the UID of the received control signal matches with its own UID, only the matching smart power strip 100 can parse the control signals, thus creating a point-to-point communication between the gateway 200 and the smart power strip 100.

Also, the smart power strips 100 can be registered on the gateway 200 in a forward registration manner, the smart power strip 100 which receives the IR signal sends an encoded registration code to the gateway 200 directly, and the other registration processes in the forward registration manner are the same as those of the driven registration manner, they are not repeated here.

After registering the smart power strips 100 on the gateway 200, the gateway 200 is capable of sending a controlling signal to the smart power strips 100, to control each of the electronic devices 3 connected to the smart power strip 100.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart power strip applied to a smart home system, comprising:
at least one socket configured to connect an electronic device;
a plug configured to connect the smart power strip to an power;
a storage;
a wireless receiver configured to receive wireless signals sent by a registration controller;
a Power Line Communication (PLC) or Optical Fiber Power Line Communication (OPLC) modem unit configured to establish communication between the smart power strip and a gateway employed in the smart home system; and
a processor unit connected to the storage, the wireless receiver and the PLC or OPLC modem unit;
wherein the processor unit stores the wireless signal in the storage and generates a registration code, the PLC or OPLC modem unit encodes the registration code and loads the encoded registration code to the power line to be transmitted to the gateway; and
wherein the registration code comprises a unique identification code of the smart power strip and a unique identification code of the registration controller.

2. The smart power strip as described in claim 1, further comprising:
a screen;
a power detecting unit configured to detect real-time electricity information of the electronic device connected on the smart power strip;
wherein the processor unit is connected to the screen and the power detecting unit, and further comprises a calculating module configured to calculate total electrical consumption of the electronic device according to the real-time electricity information, and a control module configured to control the screen to display the real-time electricity information and the total electrical consumption.

3. The smart power strip as described in claim 2, wherein a formula and an electrovalence are stored in the storage, the calculating module further calculates energy charge of the electronic device according to the formula stored in the first storage, the electrovalence and the total electrical consumption, and the control module controls the screen to display the energy charge.

4. The smart power strip as described in claim 1, wherein the socket is a three-phase socket or a two-phase socket.

5. The smart power strip as described in claim 1, wherein the wireless receiver is an Infrared receiver, and the wireless signal is an Infrared signal.

6. A smart power strip applied to a smart home system, the smart power strip connecting to a power and at least one electronic device, the smart power strip comprising:
at least one socket configured to connect the electronic device;
a plug configured to connect the smart power strip to the power;
a storage;
a wireless receiver configured to receive wireless signals sent by a registration controller;
a Power Line Communication (PLC) or Optical Fiber Power Line Communication (OPLC) modem unit configured to establish communication between the smart power strip and a gateway employed in the smart home system;
a data interface configured to exchange data with a device;
a charging unit configured to charge the device connected to the data interface;
a electronic switch configure to turn on or turn off power supply of the socket; and
a processor unit connected to the storage, the wireless receiver, the PLC or OPLC modem unit, the electronic switch, the data interface and the charging unit;
wherein the processor unit stores the wireless signal in the storage and generates a registration code, the PLC or OPLC modem unit encodes the registration code and loads the encoded registration code to the power line to be transmitted to the gateway; and
wherein the registration code comprises a unique identification code of the smart power strip and a unique identification code of the registration controller.

7. The smart power strip as described in claim 6, further comprising:
a screen;
a power detecting unit configured to detect real-time electricity information of the electronic device connected on the smart power strip;
wherein the processor unit is connected to the screen and the power detecting unit, and further comprises a calculating module configured to calculate total electrical consumption of the electronic device according to the real-time electricity information, and a control module configured to control the screen to display the real-time electricity information and the total electrical consumption.

8. The smart power strip as described in claim 7, wherein a formula and an electrovalence are stored in the storage, the calculating module further calculates energy charge of the electronic device according to the formula stored in the first storage, the electrovalence and the total electrical consumption, and the control module controls the screen to display the energy charge.

9. The smart power strip as described in claim 6, wherein the socket is a three-phase socket or a two-phase socket.

10. The smart power strip as described in claim 6, wherein the wireless receiver is an Infrared receiver, and the wireless signal is an Infrared signal.

11. The smart power strip as described in claim 6, wherein the data interface is a USB interface.

12. A smart home system comprising at least one smart power strip, a gateway communicating to the smart power strip with each other via Power Line Communication (PLC) or Optical Fiber Power Line Communication (OPLC), and a registration controller communicating to the gateway via wired or wireless communication, the smart power strip connecting to a power and at least one electronic device, the smart power strip comprising:
at least one socket configured to connect the electronic device;
a plug configured to connect the smart power strip to the power;
a storage;
a first wireless receiver configured to receive wireless signals sent by a registration controller;
a data interface configured to exchange data with a device;
a charging unit configured to charge the device connected to the data interface;
an electronic switch configure to turn on or turn off power supply of the socket; and
a processor unit connected to the storage, the wireless receiver, the electronic switch, the data interface and the charging unit;
wherein the gateway sends an identification code of the gateway and a secret code to the registration controller when the registration controller is located within the communicating range of the smart gateway and a mating program is run on the gateway;
wherein the registration controller further send an identification code of the registration controller to the gateway;
wherein the smart power strip stores the wireless signal in the storage and sends a registration code to gateway via the power line; and
wherein the registration code comprises a unique identification code of the smart power strip and a unique identification code of the registration controller.

13. The smart home system as described in claim 12, wherein the smart power strip further comprises:
a screen;
a power detecting unit configured to detect real-time electricity information of the electronic device connected on the smart power strip;
wherein the processor unit is connected to the screen and the power detecting unit, and further comprises a calculating module configured to calculate total electrical consumption of the electronic device according to the real-time electricity information, and a control module configured to control the screen to display the real-time electricity information and the total electrical consumption.

14. The smart home system as described in claim 13, wherein a formula and an electrovalence are stored in the storage, the calculating module further calculates energy charge of the electronic device according to the formula stored in the first storage, the electrovalence and the total electrical consumption, and the control module controls the screen to display the energy charge.

15. The smart home system as described in claim 12, wherein the secret code is the identification code of the gateway or input by an user.

16. The smart home system as described in claim 12, wherein the registration controller comprises:
a second wireless receiver configured to receive the identification code of the gateway and the secret code sent by the gateway;
a trigger button configured to generate a trigger signal in response of the user's pressing;
a wireless sender; and
a processor configured to control the second wireless sender to send a wireless signal comprising the identification code of the registration controller and the secret code, and control the registration controller to send a registering request to the gateway;
wherein the smart power strip further sends the registration code encoded by the secret code to the smart gateway, the registration code comprises the identification code of the smart power strip and the identification code of the registration controller; and
wherein the gateway decodes the registration code and saves the identification code of the registration controller.

17. The smart home system as described in claim 12, wherein the socket is a three-phase socket or a two-phase socket.

18. The smart home system as described in claim 12, wherein the wireless receiver is an Infrared receiver, the wireless signal is an Infrared signal.

19. The smart home system as described in claim 12, wherein the data interface is a USB interface.
